(19) United States
(12) Patent Application Publication
(10) Pub. No.: US 2022/0143899 A1
(43) Pub. Date: May 12, 2022

(54) Pipe Consolidation Apparatus and Method

(71) Applicant: Ridgway Machines Ltd, Leicester (GB)

(72) Inventor: Andrew Philip GLANVILLE, Leicester (GB)

(73) Assignee: Ridgway Machines Ltd, Leicester (GB)

(21) Appl. No.: 17/430,094

(22) PCT Filed: Feb. 12, 2020
(86) PCT No.: PCT/EP2020/053549

§ 371 Date: Aug. 11, 2021

(30) Foreign Application Priority Data
Feb. 13, 2019 (GB) 1901996.7

(51) Int. Cl. B29C 53/56; B29C 63/06; B29C 63/00; B29C 53/82; B29C 53/80; B29C 63/10; B29C 53/84; B29C 43/18; B29C 43/48; B29C 43/20; B29C 43/22; B29K 105/08; B29L 23/00; B29C 43/50

(52) U.S. Cl. CPC B29C 53/566; B29C 2043/5076; B29C 63/0004; B29C 53/822; B29C 53/8083; B29C 63/105; B29C 53/845; B29C 43/18; B29C 43/48; B29C 43/203; B29C 43/224; B29C 63/0069; B29K 2105/0881; B29L 2023/22; B29C 63/06

(57) ABSTRACT

An apparatus and method for consolidating a pipe that has been wrapped with reinforcing tape, is provided. The apparatus comprises two or more pipe consolidation devices, each having a first end, a second end, and comprising: first and second support members arranged at the first end and having a gap therebetween; and an optional third support member at the second end. Each device further comprises a peripheral band that extends around the first, second, and optionally the third support members and is substantially unsupported in the gap between the first and second support members. The apparatus additionally comprises a mounting plate having a central aperture, and two or more of the devices mounted on the mounting plate such that the first end of each device is arranged bearing against a pipe extending through the central aperture. A method of manufacturing reinforced pipe is also provided.

### FIELD OF THE INVENTION

The present invention relates to the manufacture of pipes that are reinforced by wrapping in a reinforcing tape, for example a unidirectional tape. This is commonly done to improve the strength of the pipe and to provide improved burst protection.

### BACKGROUND TO THE INVENTION

It is often desirable to increase the strength of many different pipelines in order to provide improved burst protection. Pipes that require improved burst protection include, but are not limited to, polymeric pipes, such as HDPE and nylon pipes. One method of increasing the strength of pipes is to wrap the pipe in a reinforcing tape, for example a unidirectional tape. An example of a suitable tape is Celstran® CFR-TP, which is a continuous fibre-reinforced product with a thermoplastic matrix.

Pipes can be wrapped in reinforcing tape either as a final stage of the manufacturing process or as a separate step carried out on pre-formed pipes. If the pipe is wrapped as a final stage of the manufacturing process then the pipe wrapping apparatus may be positioned at the end of a pipe manufacturing apparatus such that the pipe is wrapped in reinforcing tape after exiting the final part of a conventional pipe manufacturing apparatus. If the pipe is wrapped as a separate step then a length of pre-formed pipe can be passed through a suitable pipe wrapping apparatus.

Typically, when wrapping pipes in reinforcing tape it is necessary and/or desirable to consolidate the tape after wrapping. This can be done by heating the tape to a suitable temperature and then applying pressure to the outside of the tape to consolidate the layers of the tape together. Consolidation of the tape occurs as most reinforcing tapes, such as Celstran® CFR-RP, have a thermoplastic component that softens when heated and improves structural performance

In light of the above, there is a need for a method of processing pipes that have been wrapped in reinforcing tape in order to consolidate the wrapped tape.

### SUMMARY OF THE INVENTION

The present invention provides an apparatus for smoothing a pipe comprising:
a mounting plate having a central aperture; and
at least two pipe consolidation devices, each mounted on the mounting plate such that the first end of each device is arranged such that it can bear against a pipe extending through the central aperture; wherein
the two or more pipe consolidation devices are equally spaced around the central aperture.

The pipe consolidation devices of the apparatus of the present invention each have a first end and a second end and comprise:
a first support member and a second support member arranged at the first end of the device and having a gap therebetween; and
a peripheral band for applying pressure to a pipe formed as a substantially continuous loop; wherein

the peripheral band extends around the first, and second support members and is substantially unsupported in the gap between the first support member and the second support member.

The pipe consolidation devices of the apparatus of the present invention may further comprise a third support member arranged at the second end of the device; and the peripheral band may extend around the pipe consolidation device supported by the first, second, and third support members.

When the apparatus of the present invention is in use the pipe consolidation devices act in the following manner. Each device is positioned such that it bears against the external surface of a pipe. In particular, a pipe will be positioned such that it bears against the peripheral band in the gap between the first support member and the second support member. The pipe will then be moved axially relative to the pipe consolidation devices whilst the pipe to bear against the peripheral band. The pipe and/or the apparatus may be rotated whilst being moved axially, for example such that the pipe consolidation devices trace spiral paths along the external surface of the pipe. The pipe consolidation devices are mounted on the apparatus such that they can bear against the external surface of the pipe with a suitable pressure to consolidate the outer surface of the pipe wrapped in reinforcing tape.

As will be readily appreciated and as set out above, in most manufacturing processes in which a pipe wrapped in reinforcing tapes is consolidated the process includes a step of heating the pipe and the reinforced tape to a temperature at which consolidation of the tape is facilitated. This is achieved by heating the tape to a temperature at which the tape becomes soft and be consolidated. For example, in many such processes the wrapped pipe may be heated to a temperature of 170 C or higher and then the wrapped pipe will be consolidated. Unless other indicated by context, it is to be understood that the apparatus of the present invention will generally be used to consolidate a heated and wrapped pipe and therefore the apparatus should be constructed to be suitable to be used at elevated temperatures. Further, unless otherwise indicated by context any method according to the present invention may comprise a step of heating a wrapped pipe prior to consolidation.

It has been found that using an apparatus according to the present invention to consolidate the external surface of a pipe that has been wrapped in reinforcing tape results in a much better consolidation of the reinforcing tape.

In order to operate it is necessary that the pipe consolidation devices of the apparatus of the present invention each comprise the first, and second support members. However, embodiments of the pipe consolidation devices may comprise further support members for supporting the peripheral band around the periphery of the device. A preferred embodiment of the pipe consolidation devices of the apparatus of the present invention has a third support member positioned at a second end of the device. Further embodiments of the pipe consolidation devices may have four, five, or more support members said support members being provided around the periphery of the device.

In order to allow pressure to be evenly applied to a pipe it may be preferable that the support members of the pipe consolidation devices are rollers such that the peripheral band is movably mounted around the support members. That is, it may be preferable that the band is mounted such that it can be moved around the support members of the pipe consolidation devices as a result of a force applied to the band. This movement can be the result of rotation of the pipe relative to the pipe consolidation device as the band bears against the pipe. Mounting the peripheral band in this manner is advantageous as it can reduce friction between the band and the pipe, thereby reducing wear on the band, whilst ensuring pressure can be applied to the external surface of the pipe by the pipe consolidation device.

The peripheral band of the pipe consolidation devices of the present invention may be formed of any suitable material. Preferably the peripheral band has a smooth outer surface such that it may act to consolidate a wrapped external surface of a pipe effectively. It is necessary that the peripheral band is formed of a resilient material that can withstand wear resulting from its use. In embodiments of the invention the peripheral band may be formed of a polymer. Suitable polymers include but are not limited to silicone and Viton®.

In order to control the pressure applied to a pipe that is being consolidated by a device according to the present invention it may be advantageous that one or more of the support members is spring or pneumatically mounted. In particular, spring or pneumatically mounting one or more of the support members can help prevent excessive pressure being applied by a device to an external surface of the pipe.

In embodiments of the invention it may be advantageous that the tension on the peripheral band can be adjusted. This can be achieved in any manner apparent to the person skilled in the art. In embodiments of the invention comprising a third support member at the second end a length of the device from the first end to the second end may be adjustable such that tension on the peripheral band may be adjusted accordingly.

The pipe consolidation devices described above form part of an apparatus for smoothing a pipe. Said apparatus comprising:
a mounting plate having a central aperture; and
two or more devices according to the present invention mounted on the mounting plate such that the first end of each device is arranged such that it can bear against a pipe extending through the central aperture; wherein:
the two or more pipe consolidation devices are equally spaced around the central aperture.

The apparatus can be used by moving a pipe, wrapped in reinforcing tape, through the central aperture such that the each two or more pipe consolidation devices bear against an external surface of the pipe thereby acting to consolidate the portion of the external surface of the pipe that the devices bear against. In order that substantially the entire external surface of the pipe can be consolidated the pipe can be moved through the central aperture more than once. In addition or as an alternative, the apparatus can comprise more than two pipe consolidation devices according to the present invention, each mounted on the mounting plate such that they can bear against a pipe extending through the central aperture.

The or each pipe consolidation device of an apparatus according to the present invention will be mounted such that it is at an angle to a pipe extending through the central aperture. If perpendicular, that angle will be 90°. However, it may be preferable that each pipe consolidation device is angled away from the perpendicular. For example, each pipe consolidation device may be positioned at an angle of between 90° and 45° to a pipe extending through the central aperture, at an angle of between 90° and 60°, at an angle between, 90° and 80°, at an angle between 90° and 85°, or an angle between 85° and 80°. Angling each pipe consolidation device can provide better consolidation of the pipe. Currently it is believed that an angle between 85° and 80° is most advantageous, in particular an angle between 83° and 84° has been found to provide the best consolidation effect.

The two or more pipe consolidation devices are equally spaced around the central aperture. This ensures that the force applied to the pipe by the pipe consolidation devices is evenly spaced about the pipe to avoid bending the pipe as it passes through the central aperture. An embodiment of the apparatus of the present invention has exactly three pipe consolidation, advantageously these three devices are equally spaced around the central aperture.

The central aperture of the present invention may be shaped to conform to the external surface of a pipe with which the apparatus is used. It may be advantageous that the central aperture is substantially circular. The central aperture may be sized to be slightly larger than the diameter of a standard pipe that has been wrapped in reinforcing tape. A standard pipe is a pipe of a standardised size for a particular purpose rather than a bespoke pipe. For example, the central aperture may be sized to be slightly larger than a standard 30 mm pipe that has been wrapped in reinforcing tape. Different embodiments of the apparatus of the present invention may have differently sized central apertures that allow them to be used with different standard sizes of pipes.

In embodiments of the apparatus of the present invention each pipe consolidation device can be adjustably mounted on the mounting plate such that its position in relation to the central aperture can be adjusted. This can be done in any manner apparent to the person skilled in the art. For example, each pipe consolidation device may be mounted to a slot formed in the mounting plate by means of a releasable fixing such that when the fixing is unreleased each pipe consolidation device is held in position in the slot and when the fixing is released each pipe consolidation device is movable along the slot. As an alternative the slot may be formed in each pipe consolidation device rather than the mounting plate.

Adjusting the position of each pipe consolidation device relative to the central aperture is advantageous as it will allow an apparatus according to the present invention to be used with pipes of different sizes. In particular, for any specific pipe each pipe consolidation device can be positioned appropriately relative to the central aperture such that the pipe is consolidated by each device appropriately. Each pipe consolidation device can be positioned to extend into the central aperture a distance such that it does not prevent the pipe from being extended through the aperture but such that a pressure is applied to an external surface of the pipe by the or each device. In order to allow each pipe consolidation device to be positioned appropriately, each device may be moved into the appropriate position when a pipe is already positioned through the central aperture.

In embodiments of the apparatus the mounting plate may be rotatable such that each device may be rotated relative to a pipe extending through the aperture. In embodiments of the invention in which the mounting plate is rotatable it may be advantageous that the apparatus further comprises driving means for rotating the mounting plate. The driving means may be any suitable driving means apparent to the skilled person.

The present invention also provides a second method of manufacturing reinforced pipe comprising the steps of:
wrapping a pipe in reinforcing tape;
heating the pipe; and then
passing the pipe through the central aperture of an apparatus according to the present invention such that the pipe consolidation devices of the apparatus apply an external compressive force to the reinforcing tape.

The pipe may be wrapped in reinforcing tape in any manner apparent to the skilled person. For example, conventional tape wrapping machinery may be used in order to wrap the pipe in reinforcing tape. In order to facilitate consolidation, the pipe and reinforcing tape are heated such that the reinforcing tape reaches an appropriate temperature for consolidation. Heating can be done simultaneously with the wrapping process or can be done subsequent to the wrapping process as a separate step. After wrapping and heating, the pipe will be passed through the central aperture of the mounting plate whilst each pipe consolidation device of the apparatus is arranged to apply an external compressive force to the reinforcing tape of the pipe.

In the second method of the present invention the pipe may be rotated relative to each pipe consolidation device as the pipe is passed through the aperture. This may be achieved by rotating the mounting plate, rotating the pipe, or rotating both the pipe and the mounting plate.

Further features and advantages of the present invention will be apparent from the preferred embodiment that is shown in the Figures and is described below.

### DRAWINGS

FIG. 1 shows a pipe consolidation device of an apparatus according to the present invention;

FIG. 2 shows the pipe consolidation device according to FIG. 1 in use smoothing a pipe; and

FIG. 3 shows an apparatus according to the present invention.

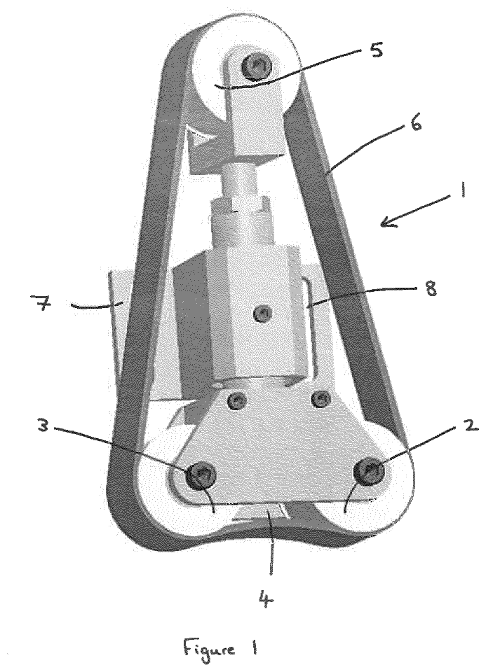

A pipe consolidation device 1 of an apparatus according to an embodiment of the present invention is shown in FIG. 1. The device 1 has a first support member 2 and a second support member 3 arranged at a first end of the device. There is a gap 4 between the first support member 2 and the second support member 3. A third support member 5 is arranged at a second end of the device 1. The first, second, and third support members 2, 3, and 5 are each rollers that are mounted on the device 1 such that are able to freely rotate. A peripheral band 6 formed of a continuous band of polymeric material is mounted around the device on the first, second, and third support members 2, 3, 5 and is substantially unsupported in the gap 4. The peripheral band 6 is only supported by the first, second, and third support members 2, 3, 5 and, as such, can be rotated about the device 1.

The device 1 has a central mounting portion 7 formed between the first end and the second end that allows it to be bolted to other components. The mounting portion 7 has two slots 8 formed therein to allow the device 1 to be adjustably mounted. In particular, the device 1 can be slidably mounted to another component by means of a bolt located through each of the slots 8. By loosening the bolts, sliding the device 1, and then retightening the bolts the positioning of the device 1 relative to the other component can be varied.

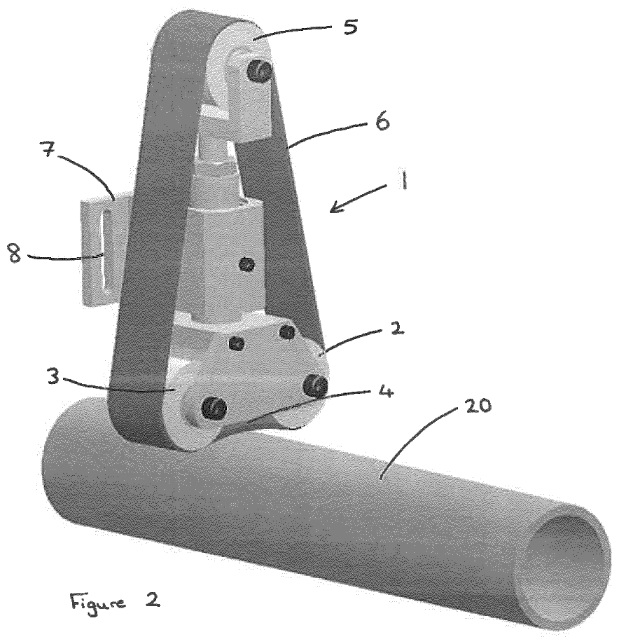

The use of the device 1 of FIG. 1 to consolidate a wrapped pipe 20 is shown in FIG. 2. The device 1 is positioned to bear against a pipe 20 that has been wrapped in a reinforcing tape (not shown). In particular, the device 1 is positioned such that the peripheral band 6 presses against an outer surface of the pipe 20 at the gap 4 of the device. This provides an even pressure over the portion of the surface of the pipe 20 against which the peripheral band 6 is in contact. The pressure of the peripheral band 6 against the pipe 20 is sufficient to consolidate the tape wrapped around an outer surface of the pipe. The pipe 20 may then be rotated and/or moved axially relative to the device 1 such that a substantial portion of the outer surface of the pipe is consolidated. This is may be achieved by rotating the pipe 20 and/or rotating the device 1.

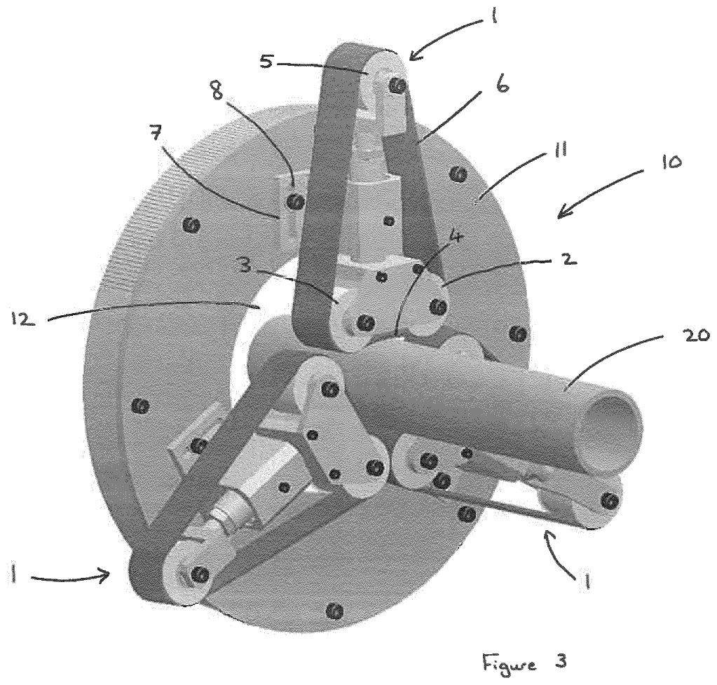

An apparatus 10 according to the present invention is shown in FIG. 3. The apparatus 10 is shown in use consolidating the outer surface of a pipe 20 that has been wrapped in reinforcing tape (not shown). The apparatus 10 consists of a circular mounting plate 11 having a circular central aperture 12 and three pipe consolidation devices 1 as shown in FIG. 1. The devices 1 are each mounted to a first planar face of the mounting plate 11 and are arranged such that their first ends extend over the central aperture 12. The devices 1 are evenly spaced about the central aperture 12. Each device 1 is slidably mounted to the mounting plate 11 by means of a pair of bolts mounted through the slots 8 formed in the mounting portion 7. This allows the precise position of the devices 1 to be varied in a simple manner, as discussed above.

When the apparatus 10 is in use a pipe 20 wrapped in reinforcing tape (not shown) is positioned through the central aperture 12 and the devices 1 are arranged such that they bear against an outer surface of the pipe. In particular, each device 1 is positioned such that the peripheral band 6 presses against an outer surface of the pipe 20 at the gap 4 of the device, this provides an even pressure on a contacting portion of the outer surface of the pipe. The pipe 20 is then rotated relative to the mounting plate 11 and the devices 1. This can be achieved by rotating the mounting plate 11 and/or rotating the pipe 20. The pipe 20 is then moved axially through the central aperture 12 whilst continuing the relative rotation of the pipe 20 and the mounting plate 11. In this manner, substantially the entire outside portion of the pipe 20 can be consolidated by the action of the devices 1.

The relative rotation of the pipe 20 and the mounting plate 11 can act to cause the rotation of each peripheral band 6 about each device 1. This prevents excessive wear to any particular portion of a peripheral band 6 and helps provide an even pressure across the outer surface of the pipe 20 to provide an even consolidation effect.

It is to be understood that the embodiments shown in the Figures are illustrative only and are shown to aid understanding of the invention.

1.-12. (canceled)

13. An apparatus for consolidating a pipe, comprising:
a mounting plate having a central aperture; and
two or more pipe consolidation devices, each pipe consolidation device having a first end and a second end and comprising
a first support member and a second support member arranged at the first end of the device and having a gap therebetween, and
a peripheral band for applying pressure to a pipe formed as a substantially continuous loop,
wherein the peripheral band extends around the first, and second support members and is substantially unsupported in the gap between the first support member and the second support member,
each pipe consolidation device is mounted on the mounting plate such that the first end of the pipe consolidation device is arranged such that it bears against a pipe extending through the central aperture, and
the two or more pipe consolidation devices are equally spaced around the central aperture.

14. The apparatus according to claim 13, having exactly three pipe consolidation devices.

15. The apparatus according to claim 13, wherein the, or each, pipe consolidation device is adjustably mounted on the mounting plate such that its position in relation to the central aperture can be adjusted.

16. The apparatus according to claim 13, wherein the mounting plate is rotatable.

17. The apparatus according to claim 16, further comprising driving means for rotating the mounting plate.

18. The apparatus according to claim 13, wherein
each pipe consolidation device further comprises a third support member arranged at the second end of the device, and
the peripheral band extends around the pipe consolidation device supported by the first, second, and third support members.

19. The apparatus according to claim 18, wherein a length of each pipe consolidation device from its respective first end to its respective second end can be adjusted to adjust the tension on the peripheral band.

20. The apparatus according to claim 13, wherein the first support member and the second support member of each pipe consolidation device are rotatable rollers.

21. The apparatus according to claim 13, wherein the peripheral band of each pipe consolidation device is a formed of a polymer.

22. The apparatus according to claim 13, wherein one or both of the first support member and the second support member of each pipe consolidation device is spring mounted.

23. A method of manufacturing reinforced pipe, comprising the steps of:
wrapping a pipe in reinforcing tape;
heating the pipe; and then
passing the pipe through the central aperture of the apparatus according to claim 13 such that the two or more pipe consolidation devices of the apparatus apply an external compressive force to the reinforcing tape.

24. The method according to claim 23, wherein the pipe is rotated relative to the apparatus as the pipe passes through the central aperture.
